(19) United States
(12) Patent Application Publication
(10) Pub. No.: US 2024/0037537 A1
(43) Pub. Date: Feb. 1, 2024

(54) INFRASTRUCTURE FOR DIGITAL ASSET MANAGEMENT

(71) Applicant: Infanity, Inc., Baltimore, MD (US)

(72) Inventors: Daniel Jon Kleinman, Baltimore, MD (US); Renata Diane Lowenbraun, Baltimore, MD (US)

(21) Appl. No.: 18/362,645

(22) Filed: Jul. 31, 2023

Related U.S. Application Data
(60) Provisional application No. 63/369,973, filed on Jul. 31, 2022.

(51) Int. Cl. G06Q 20/36; G06F 16/483

(52) U.S. Cl. CPC G06Q 20/36; G06F 16/483; G06Q 2220/10

(57) ABSTRACT

Briefly, example methods, apparatuses, and/or articles of manufacture are disclosed that may be implemented, in whole or in part, using one or more computing devices to facilitate and/or support one or more operations and/or techniques for infrastructure for digital asset management, such as implemented in connection with one or more computing and/or communication networks and/or protocols.

### CROSS-REFERENCE TO RELATED APPLICATIONS

The present application claims priority under 35 U.S.C. § 119 to U.S. Provisional Application Ser. No. 63/369,973, entitled “NFT Player,” filed on Jul. 31, 2022, which is assigned to the assignee hereof and which is expressly incorporated herein by reference.

### BACKGROUND

### Field

The present disclosure relates generally to computer and/or electronic infrastructures and, more particularly, to infrastructure for digital asset management.

### Information

The Internet is widespread. The World Wide Web or simply the Web, provided by the Internet, is growing rapidly, at least in part, from the large amount of electronic content being added seemingly on a daily basis. A wide variety of electronic content and/or data in the form of digital signals, such as, for example, text files, images, audio files, video files, web pages, or the like is continually being identified, located, retrieved, collected, stored, communicated, etc. Increasingly, electronic content is being acquired, collected, communicated, etc. by a number of mobile computing devices. Often, such devices are capable of leveraging existing Internet or like infrastructure as part of a system of interconnected and/or internetworked physical devices in which computing is embedded into hardware so as to facilitate and/or support devices' ability to acquire, collect, and/or transfer content over one or more communications networks, for example, such as via a variety of protocols, domains, and/or applications.

More recently, a newer iteration of the World Wide Web—Web3, also known as Web 3.0—which incorporates various decentralization or like technologies is becoming more prominent. As one example, electronically distributed ledger technology (DLT) enables at least partial replication of electronic content in a manner that is distributed across a plurality of computing devices, which may include peer computing devices. Generally, electronically distributed ledger technologies utilize peer-to-peer (P2P) computer networks and consensus algorithms so that the ledger is reliably replicated across distributed computer nodes (servers, clients, etc.). A form of electronically distributed ledger technology is blockchain technology, which may, for example, be on a public or private network, or any combination thereof.

This or like technology has enabled a paradigm for acquiring and/or managing digital assets that can be used to certify ownership and/or authenticity in partial- or zero-trust environments (e.g., the Internet, etc.). These or like digital assets may be used to conduct transactions, exchange verifiable data, achieve coordination across organizations and on the web, etc. Users can also independently control custody of such assets in digital storage and can interact with one another in a peer-to-peer and/or some other manner. Associated communications networks typically support transaction reconciliation, linkage, and/or storage in consolidated, integrity-protected electronically distributed ledgers forming reliable record-keeping environments. More reliable and/or robust infrastructure for effectively and/or efficiently managing these or like digital assets, however, may be a common barrier to their technological implementation. Thus, how to more effectively and/or efficiently implement such infrastructure, including for mobile computing devices operating in partial- or zero-trust environments, for example, continues to be an area of development.

### BRIEF DESCRIPTION OF THE DRAWINGS

Claimed subject matter is particularly pointed out and distinctly claimed in the concluding portion of the specification. However, both as to organization and/or method of operation, together with objects, features, and/or advantages thereof, it may best be understood by reference to the following detailed description if read with the accompanying drawings in which:

FIG. 1 is an example environment in which some implementations may be deployed or practiced.

FIG. 2 is an example method that may be performed in accordance with some implementations.

FIG. 3 is an example method that may be performed in accordance with some implementations.

FIG. 4 is an example system that may operate in accordance with some implementations.

FIG. 5 is a schematic diagram illustrating an implementation of an example computing environment.

Reference is made in the following detailed description to accompanying drawings, which form a part hereof, wherein like numerals may designate like parts throughout that are corresponding and/or analogous. It will be appreciated that the figures have not necessarily been drawn to scale, such as for simplicity and/or clarity of illustration. For example, dimensions of some aspects may be exaggerated relative to others, one or more aspects, properties, etc. may be omitted, such as for ease of discussion, or the like. Further, it is to be understood that other embodiments may be utilized. Furthermore, structural and/or other changes may be made without departing from claimed subject matter. References throughout this specification to “claimed subject matter” refer to subject matter intended to be covered by one or more claims, or any portion thereof, and are not necessarily intended to refer to a complete claim set, to a particular combination of claim sets (e.g., method claims, apparatus claims, etc.), or to a particular claim. It should also be noted that directions and/or references, for example, such as up, down, top, bottom, and so on, may be used to facilitate discussion of drawings and are not intended to restrict application of claimed subject matter. Therefore, the following detailed description is not to be taken to limit claimed subject matter and/or equivalents.

### DETAILED DESCRIPTION

References throughout this specification to one implementation, an implementation, one embodiment, an embodiment, and/or the like means that a particular feature, structure, characteristic, and/or the like described in relation to a particular example, implementation and/or embodiment is included in at least one example, implementation and/or embodiment of claimed subject matter. Thus, appearances of such phrases, for example, in various places throughout this specification are not necessarily intended to refer to the same implementation and/or embodiment and/or to any one particular implementation and/or embodiment. Furthermore, it is to be understood that particular features, structures, characteristics, and/or the like described are capable of being combined in various ways in one or more implementations and/or embodiments and, therefore, are within intended claim scope. Unless explicitly indicated to the contrary, reference to “another example” and/or “a further example” does not indicate that the described example is an exclusive alternative to a preceding example. In general, such examples may be alternatives to and/or additions to previous examples. In general, of course, as has always been the case for the specification of a patent application, these and other issues have a potential to vary in a particular context of usage. In other words, throughout the disclosure, particular context of description and/or usage provides helpful guidance regarding reasonable inferences to be drawn; however, likewise, “in this context” in general without further qualification refers at least to the context of the present patent application.

Some example methods, apparatuses, and/or articles of manufacture are disclosed herein that may be used, in whole or in part, to facilitate and/or support one or more operations and/or techniques for infrastructure for digital asset management. As discussed in greater detail below, particular examples may include, one or more computing and/or communications platforms for direct and/or indirect management of digital assets, presentation and/or dissemination of associated digital content, for facilitating electronic transactions involving digital assets, for interfacing with one or more decentralized and/or centralized applications, entities, or the like.

As will also be seen, in some instances, these or like approaches may provide improvements in computing devices and/or computing processes, such as for electronically distributed ledger or like technologies, for example, by facilitating interaction between a variety of digital systems, by improving usability of systems involving DLTs, by increasing the availability and/or dissemination of digital content associated with digital assets, or the like. For example, as also discussed below, using these or like approaches, a user of a computing device (e.g., mobile device, etc.) may, for example, be capable of accessing, obtaining, activating, etc. one or more digital assets and may more efficiently and/or more effectively manage the digital assets, such as in a more personal and/or more suitable manner. In some instances, these or like approaches may also allow a user to more effectively and/or more efficiently interact via one or more applicable web services, such as in a decentralized manner and/or for the purposes of digital content dissemination, among others, as will also be seen.

For ease of understanding, various examples are discussed herein in terms of blockchain networks, although claimed subject matter should not be so limited. Typically, a “blockchain” refers to an electronically distributed digital ledger of cryptographically-signed records (e.g., of on-line transactions, etc.) that are grouped into blocks, where each block is cryptographically linked to the previous one. After validation, blocks are replicated, in whole or in part, across copies of the ledger within the network, and any conflicts are resolved automatically using established rules. A “blockchain network” is a network of nodes that provide a particular blockchain. The terms “blockchain” and “blockchain network” may be used interchangeably herein, where the context clarifies whether the reference is to a blockchain network or the underlying blockchain. Blockchains may “permissionless” where users' permissions are equal and not set by any administrator and/or consortium. Such permissionless blockchains include consensus models that determine which block are added to the network, such as proof-of-work and/or proof-of-stake models. In contrast, in a “permissioned” blockchain, nodes must be granted permissions to use the system, which is typically provided by and administrator, consortium, and/or other entity. The scope of this description should be understood to include permissioned, permissionless, and/or any other type of blockchain technology. Additionally, as indicated above, the scope should not be understood to be limited to blockchains. Unless explicitly indicated to the contrary, any type of distributed networked database may be utilized, in whole or in part, depending on an implementation.

A “digital asset,” as the term used herein, should be interpreted broadly and refers any asset that is purely digital (e.g., exists in a digital form, etc.) is a digital representation of a physical asset, or is a combination thereof. For example, digital assets may include works of art (such as music and/or music videos, television shows, images, movies, paintings, photographs, pictures, etc.) embodied in a digital medium and/or digital representations of works of music and/or art embodied in a physical medium. As another example, digital assets may include assets that are native to the blockchain protocol, such as “cryptocurrencies” which are transferrable credits, units, or the like, that may be cryptographically sent from one user to another. A “token” is a representation of a digital asset that typical relies on a blockchain and/or other type of an electronically distributed ledger technology. Various examples are described with respect to “non-fungible” and/or “stateful” tokens; “non-fungible” tokens represent unique assets that are external to the blockchain (i.e., “off-chain”) while “stateful” tokens represent unique assets that are internal to the blockchain (i.e., “on-chain”), typically with respect to on-chain data registries. Such tokens may or may not be in a one-to-one relationship to their underlying assets. For example, multiple non-fungible tokens may represent a given asset or only a single non-fungible token may represent a given asset. “Fungible” tokens represent interchangeable digital assets. A “hybrid” token represents any combination of non-fungible, stateful, and/or fungible assets. While various examples may be described by way of reference to tokens, the scope of the description is inclusive of any other digital unit of value that is indicative and/or representative of one or more digital assets.

The term “wallet”, as used herein, refers to a “digital wallet”, which is an application and/or appliance that may be used to generate, manage, store, and/or use private and public keys. A wallet may be implemented as software, hardware, or a combination thereof. Wallets may include “hot wallets” that are connected and/or connectable to the Internet and/or other network for high-accessibility, “cold wallets” that are air-gapped and require physical human interaction, and “warm wallets” that provide a proxy connection between a cold wallet and a hot wallet. “Custodial” wallets are wallets that have delegated permission to conduct blockchain transactions on behalf of a user. A “vault” is a wallet that is internal to the blockchain and can serve as a receptacle for tokens with built-in rules and automated agreements. Of course, a wallet might store other items and/or might present its stored keys transparently as other items. For example, a wallet might store one or more tokens and/or might present the keys associated with a particular token as a representation of the token.

“Digital content” refers to signals, such signal packets, for example, and/or states, such as physical states on a memory device, for example, but otherwise is employed in a manner irrespective of format, such as any expression, representation, realization, and/or communication, for example. Digital content may comprise, for example, any information, knowledge, and/or experience, such as, again, in the form of signals and/or states, physical and/or otherwise. Digital content may include content in a form that although not necessarily capable of being perceived by a human, (e.g., via human senses, etc.) but that may nonetheless be transformed into a form capable of being so perceived, such as visually, haptically, and/or audibly, for example. Non-limiting examples may include text, audio, images, video, combinations there-of, or the like. “Presenting” digital content refers to making content available in a perceptible form. Non-limiting examples may include displaying content on a display device, playing audio content on speakers, actuating haptic devices, combinations thereof, or the like.

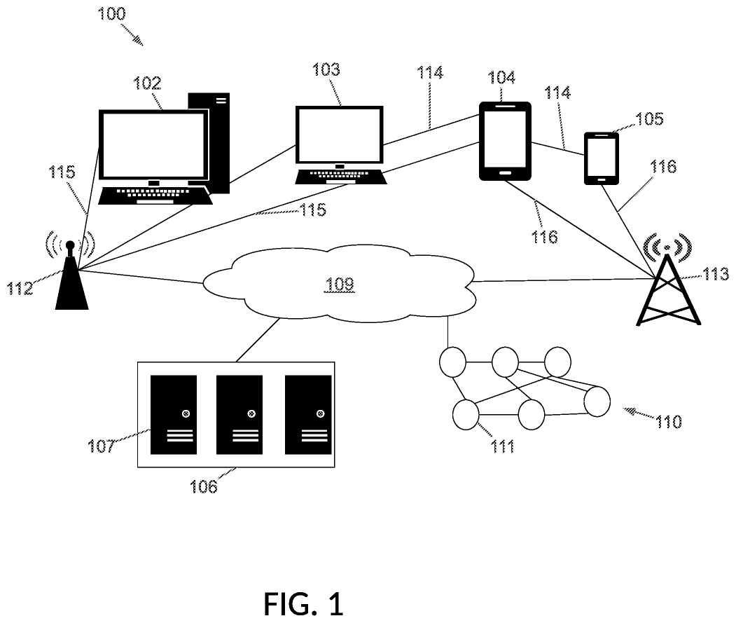

FIG. 1 is a schematic diagram illustrating features associated with an implementation of an example operating environment 100 capable of facilitating and/or supporting one or more platforms and/or techniques for infrastructure for digital asset management. It should be appreciated that operating environment 100 is described herein as a non-limiting example that may be implemented, in whole or in part, in the context of various wired and/or wireless communications networks, and/or any suitable portion and/or combination of such networks. For example, these or like networks may include one or more public networks (e.g., the Internet, the World Wide Web), private networks (e.g., intranets), wireless wide area networks (WWAN), wireless local area networks (WLAN, etc.), wireless personal area networks (WPAN), telephone networks, cable television networks, Internet access networks, fiber-optic communication networks, waveguide communication networks, wireless radio links, and/or the like. It should also be noted that claimed subject matter is not limited to a particular network and/or operating environment.

The example environment 100 includes a plurality of user devices 102, 103, 104, 105, including a personal computer (PC) 102, laptop computer 103, tablet device 104, and smartphone 105. Other user devices may include personal digital assistants (PDAs), personal audio and/or video devices, personal navigation devices, or the like. Additionally, such user devices may be virtualized devices residing on another computing infrastructure, such as a data center comprising a plurality of servers. These devices are connected to a public network 109, such as the Internet. Such connections may include local connections 115 to an access point 112 that provides a routed connection to the Internet 109. For example, wireless connections 115 may be implemented according to one of the 802.11 wireless networking protocols. Other such connections may include cellular network connections 116 that provide a routed connection to the Internet 109 via a telecommunications infrastructure 113, for example, via, at least in part, wireless radio links, or the like. For example, cellular communications connections 116 may be implemented according to the 5G and/or 4G telecommunications protocols. The devices may also be capable of forming ad-hoc and/or ongoing device-to-device (e.g., peer-to-peer) connections 114. For example, ad-hoc connections may be implemented according to the Bluetooth protocol, and/or a near field communications (NFC) protocol.

In this example, the user devices are connected via the Internet 109 and/or other Internet Protocol (IP)-type infrastructure to one or more hosted services 106. For example, services 106 may be hosted on one or more servers 107 located in one or more data centers. Such services may include a variety of discrete services provided by one or more software application components. Such components may communicate with each other and with the user devices according to various protocols, such as web-service technologies (e.g., HTML, asynchronous JavaScript and XML (AJAX), and application programming interfaces (APIs) (e.g., JavaScript Object Notation (JSON) based RESTful interfaces). For example, servers 107 may comprise one or more content servers, transaction servers, update servers, back-end servers, management servers, database servers, crowdsourcing servers, network-related servers, or the like.

The example environment 100 includes one or more blockchain networks 110, and/or other electronically distributed ledger networks. The blockchain network 110 comprises a plurality of nodes 111, which are individual computing systems within the blockchain network 110. Such nodes 111 may include full nodes and lightweight nodes. A lightweight node does not store an entire copy of the blockchain and often passes its data to full nodes to be processed. A full node stores a copy of the blockchain data and passes along the data to other nodes. In some implementations, such as permissionless blockchains, the full nodes may also participate in validation and authentication procedures. In some cases, full nodes may be divided into publishing nodes and non-publishing nodes. A publishing node performs the duties of a full node and additionally extends the blockchain by creating and publishing new blocks. A non-publishing node performs the duties of a full node but does not extend the blockchain itself. The nodes 111 may be implemented on a variety of different computing platforms and/or architectures. For example, a node 111 may be implemented using software executed by a general-purpose computing architecture, such as a Von Neumann architected general purpose computer including a central processing unit (CPU) and/or a general-purpose graphical processing unit (GPGPU). For example, such a node 111 may be implemented on a real and/or virtualized instance of a user device such as one of the devices 102, 103, 104, 105 or a server 107. As another example, the node 111 may implemented using an application specific integrated circuit (ASIC) and/or other specialized circuitry comprising hardware configured to perform some or all of the node duties. In further examples, the node 111 may be implemented using any combination of software and hardware.

In some cases, the blockchain 110 may surface one or more platforms for executing code. For example, a blockchain protocol may provide an application-specific instruction set, such as Bitcoin Script, and/or a general-purpose execution environment, such as the Ethereum Virtual Machine. Such protocols allow the development of “smart contracts”, which are self-executable computer programs that automate one or more actions on a distributed ledger or like network, such as upon satisfaction of certain predefined conditions. These or like executable programs may be executed by nodes 111 within the blockchain network (for example, by publishing nodes) such that all participating nodes derive the same results for the execution and the results are recorded on the blockchain. These programs may include executable code (sometimes referred to as functions) as well as data (sometimes referred to as state). Some such platforms may also allow for programs to reference and/or incorporate off-chain data. Different platforms may provide various methods for accessing such executables and enabling the executables to interact with the underlying blockchain network 110. In some cases, the executables may be granted accounts on the blockchain. For example, for Ethereum, smart contracts are accessible via a special address called a contract account. This account address is created when a smart contract is deployed (the address for a contract account is deterministically computed from the smart contract creator's address). This contract account allows for the contract to be executed whenever it receives a transaction, as well as create additional smart contracts in turn. In other cases, the executables may be external and controlled through public-key cryptography via end user-controlled techniques. In these cases, authorizations are provided by signing the blockchain transactions with the owner's private key(s). Further cases may employ combinations of account-based and user-controlled executable paradigms.

Blockchain network 110 may be implemented, in whole or in part, in accordance with protocols that define formats for tokens, such as stateful and/or non-fungible tokens. As discussed above, tokens are units of value recordable in electronically distributed ledgers that are assigned to blockchain accounts. Transactions involving tokens typically include, for example, authorization, ensuring authenticity and preventing modification and tampering without consent. Token data models may specify token format and specify operations at the protocol level (for example, for token creation and supply/lifecycle management) and/or at the account level (for example, for individual token transfers). These models have different capabilities and scopes, which additional token management protocols can complement. In some cases, elements of data models for such tokens may be built into the blockchain programming protocol. In other cases, the data models may be built as separate protocols on top of the block chain network, or may be a mix of application-defined and built-in elements. In some cases, token data models may follow standard-based definitions.

Various types of token-related operations may be defined by built-in and/or application-defined token protocols. These operations are typically executed using calls to application programming interfaces (APIs). For example, tokens may be associated with specific instances of APIs that are defined in accordance with a wider API model. Examples of such operations include token creation (which may be referred to as “mint”) operations and/or token transfer operations. Other examples include delegated operations that allow single-use, conditioned, and/or permanent authorization for calls to other API operations.

A transfer operation API may define methods to cause tokens to be transferred to accounts. Different transfer operations may have limitations on what addresses the token can be transferred to. For example, such APIs may allow third parties to place transfer restrictions and/or holds. For instance, a content creator might restrict non-fungible tokens associated with underlying works of art to being transferred within a predefined community of members.

A token mint operation creates and distributes new tokens. Various types of mint operations may be employed in different blockchain protocols. For example, a push-based mint operation for a non-fungible token may instantiate the token with a unique identifier and a reference to a digital asset and assign the newly created token to a receiving account. As another example, a pull-based mint operation can give minting rights to specific accounts and/or holders of other tokens. For example, a content creator might create a number of stateful tokens that enable holders to redeem the token for a non-fungible token. For instance, a musician might distribute a Quick Response (QR) code to concert-goers. The QR code could provide an address to a stateful token that has a count of available non-fungible tokens associated with songs. The stateful token may be further be associated with code (i.e., a smart contract) that provides an API that includes operations to mint non-fungible tokens. In this example, the count state of the stateful token may be decremented with each mint operation, fixing the total number of available non-fungible tokens associated with the QR code. As another example, a stateful token's API may include authentication requirements, such as a password, allowing password holders to trigger a mint operation for an associated non-fungible token. This may allow effective dissemination of non-fungible tokens to users before they have a wallet.

Even though a certain number of computing platforms and/or devices are illustrated herein, any number of suitable computing platforms and/or devices may be implemented to facilitate and/or support one or more techniques and/or processes associated with operating environment 100. Again, these are merely example implementations, and claimed subject matter is not limited in this regard.

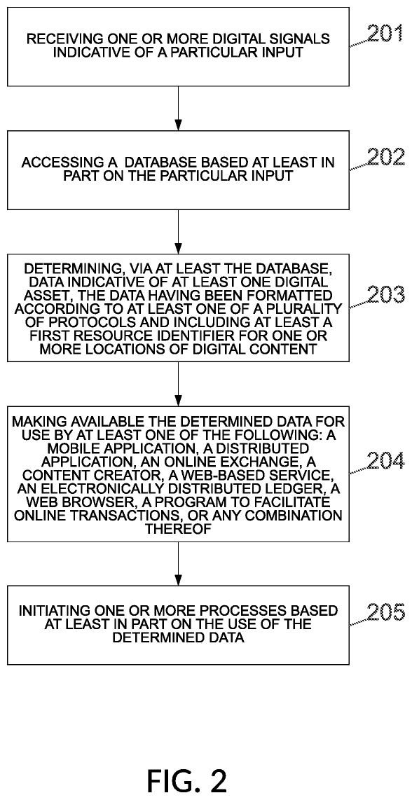

Attention is now drawn to FIG. 2, which is a flow diagram illustrating an implementation of an example process that may be performed, in whole or in part, to facilitate and/or support one or more operations and/or techniques for infrastructure for digital asset management. Even though one or more operations are illustrated and/or described concurrently and/or with respect to a certain sequence, other sequences and/or concurrent operations may be employed. In addition, although the description below references particular aspects and/or features illustrated in certain other figures, one or more operations may be performed with other aspects and/or features.

The example process may begin, for example, at operation 201 with receiving one or more digital signals indicative, in whole or in part, of a particular input. For instance, operation 201 may include receiving signals via a touch-sensitive screen, a computer mouse, a keyboard, and/or a voice-controlled interface. For example, operation 201 may include receiving a user selection of a certain presented information element. As an example, a screen may display a list of digital content that can be accessed pursuant to tokens held in a wallet. In this example, operation 201 might include receiving a signal indicative of a user selecting one or more items of digital content. As another example, a screen may display a list of available wallets that hold tokens associated with digital content. In this example, operation 201 might include receiving a signal indicative of a user selecting one or more wallets. Further examples of receiving digital signals indicative of a particular input should be understood as example implementations of operation 201.

The example process may include, for example, operation 202, which includes accessing a database based at least in part on the particular input received in operation 201. For example, operation 202 may include determining a primary and/or foreign key for a relational database based on the particular input. For example, operation 202 may including searching the database using information determine based on the particular input. As another example, the particular input may refer to a specific record in the database. In various implementations, the database may be locally stored, remotely stored, or a combination thereof, it may be distributed or monolithic, and/or may be structured and/or unstructured. In some examples, operation 202 may include selecting the database from a set of databases based on the particular input. For example, the input may indicate a particular type of user selection, where different types of selection correspond to different databases. Operation 202 may also include accessing the database based on other particular inputs and/or additional information, such as a device and/or wallet identifier.

The example process may include, for example, operation 203, which includes determining, via at least the database, in whole or in part, data indicative of at least one digital asset. In this example, the data may have been formatted according to at least one of a plurality of protocols and may include at least a first resource identifier for one or more locations of digital content. As an example, the data indicative of the at least one digital asset may comprise one or more tokens, such as non-fungible and/or stateful tokens. The plurality of protocols may include protocols defining the format and/or model for data indicative of digital assets. Additionally, the plurality of protocols may include protocols defining electronically distributed ledger operations that may be performed with respect to the data. As discussed above, these protocols may include definitions for built-in operations and formatting inherent to an electronically distributed ledger protocol, for operations and formatting built on top of the distributed ledge protocol, or a combination thereof. In some examples, operation 203 may include determining which protocol the data has been formatted according to. The resource identifier for one or more digital content may be formatted according to one or more of such protocols. It may include, for example, a predefined data field storing a Uniform Resource Identifier (URI), which may point to a website and/or storage address (e.g., a local storage address, a remote storage address, etc.) that stores the digital content. As another example, the resource identifier may be an address to a block on a blockchain that stores the digital content and/or that links to the digital content. In some examples, the locations may comprise at least one of a memory, the database itself, a local storage, a remote storage, or any combination thereof.

In some examples, the data may be indicative of multiple digital assets, located in multiple locations, and may be formatted according to multiple protocols. In these examples, operation 203 may include determining whether the data is indicative of an additional digital asset comprising additional digital content and has been formatted according to a different protocol than the at least one of the plurality of protocols, wherein the additional digital content has been identified via a second resource identifier.

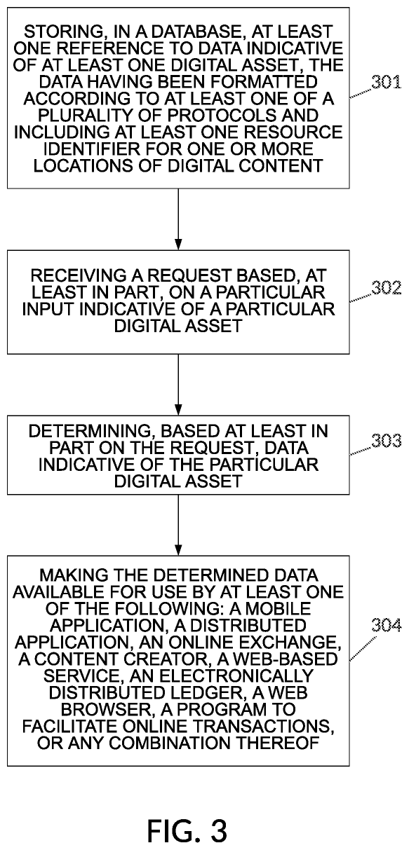

The example process may include, for example, operation 204, which includes making the determined data, in whole or in part, available for use. For example, the determined data may be made available for use by a mobile application, a distributed application, an online exchange, a content creator, a web-based service, an electronically distributed ledger, a web browser, a program to facilitate online transactions, or any combination thereof. As an example, operation 204 may include retrieving the digital content identified via the resource identifier. For example, the data may be made available to a mobile application to create lists of available tokens, such as NFTs and/or fungible tokens, and/or to create lists of digital content associated with such tokens. As another example, the data may be made available to a distributed application to allow interaction with other users through a blockchain transaction. As another example, the data may be made available to an electronically distributed ledger, online exchange, and/or program to facilitate online transactions, to conduct an operation related to the data as defined by the protocol. Further examples are discussed below with respect to FIGS. 3, 4, and 5.

The example process may include, for example, operation 205, which includes initiating one or more processes based at least in part on the use of the determined data. For example, the determined data in operation 204 may comprise media files and operation 205 may include presenting the media files on a device. For example, presenting the media files may comprise playing music files on a speaker and/or simultaneous audio and visual presentation of videos on a display and speaker. As an example, operation 205 might comprise playing a set of music files in a shuffled/random order, or the like. In some examples, operation 205 may include presenting a list of available digital content, for example by displaying the list on a computing device. In these examples, operation 205 may also include receiving input indicative of a selection of the listed digital content, and retrieving the selected digital content. Retrieving the digital content may be performed in accordance with the protocol(s) corresponding to the digital content.

In some examples, operation 205 may include storing metadata associated with the digital content in the database. As non-limiting examples, metadata may include an identifier indicative of inclusion in a grouping such as a playlist, inclusion in a user's “likes” and/or “favorites”. Metadata may include a statistic of the digital content associated with the digital asset such as a play count, price, release data, and/or status of the associate content on a third party list such as a “top-ten” list. Metadata may include a categorical descriptor of the digital content associated with the digital asset such as a genre, a tempo, a descriptor of the artist (such as status as a solo artist, artist in a band, and/or artist of a given gender, etc.) a name of an artist, or the like. The metadata may also include user-configurable, user-generated, and/or other customized metadata, any combination of the foregoing, or the like. In some examples, such metadata may be utilized in other method steps. For example, operation 201 might comprise receiving one or more digital signals indicative of metadata and operation 202 might comprise determining data indicative of digital assets associated with the selected metadata.

As another example, operation 205 may comprise initiating an electronic transaction involving a digital asset of the at least one digital assets. For example, the electronic transaction may be initiated according to a corresponding protocol of the plurality of protocols. For instance, operation 205 may comprise calling a token transfer operation defined by an API (e.g., a smart contract) instantiated with respect to the token. As non-limiting examples, the transaction may be a purchase of a non-fungible token, the sale of a non-fungible token, and/or initiating a mint and deliver operation for a non-fungible token based on the possession of a corresponding stateful token. In some instances, initiating the online transaction may comprise initiating an update of the electronically distributed ledge according to the corresponding protocol. For example, operation 205 may comprise publishing a new block on a blockchain that effectuates a transfer operation and/or mint operation. In some cases, the protocol establishing the available operations may be built-in to an electronically distributed ledger technology, may be programmed on top of the electronically distributed ledger, may be defined independently of the electronically distributed ledger, and/or may be defined in a hybrid and/or other manner.

Attention is now drawn to FIG. 3, which is a flow diagram illustrating an implementation of an example process that may be performed, in whole or in part, to facilitate and/or support one or more operations and/or techniques for digital asset management infrastructure. For example, the process illustrated in FIG. 3 may be performed by a first system, such as a server-based software platform, interacting with a second system, such as a user device, that performs the process illustrated in FIG. 2. Even though one or more operations are illustrated and/or described concurrently and/or with respect to a certain sequence, other sequences and/or concurrent operations may be employed. In addition, although the description below references particular aspects and/or features illustrated in certain other figures, one or more operations may be performed with other aspects and/or features.

The example process may include, for example, operation 301, which includes storing, in whole or in part, in a database, at least one reference to data indicative of at least one digital asset. The data may be formatted, in whole or in part, according to at least one of a plurality of protocols and include at least one resource identifier for one or more locations of digital content. For example, operation 301 may include storing a reference to a wallet storing a token and/or tokens associated with one or more digital assets. For example, operation 301 may include storing reference and access data for wallets provide by other platforms. For instance, operation 301 may be performed to provide cross platform infrastructure for digital asset management. As another example, operation 301 may include storing the data itself in the database. For example, operation 301 may be performed by a delegated wallet with access privileges to a subscriber's wallet. In some instances, the data, its formatting, and the resource identifier may be as described with respect to operation 202 of FIG. 2.

As another example, operation 301 may include storing references to data indicative of digital assets that are available. For example, operation 301 may include storing a list of non-fungible tokens associated with various criteria. For instance, operation 301 may include storing a list of NFTs associated with newly released songs by an artist. As a further example, the criteria may be user configurable. For instance, a user might mark certain assets as favorites, and operation 301 may include storing references to NFTs that are available and associated with those favorites.

As discussed above, the database may also include metadata associated with the digital asset. In these examples, operation 301 may further include receiving metadata associated with a digital asset in the database. As non-limiting examples, the metadata may include one of the following: an identifier indicative of inclusion in a grouping, a statistic of the digital content associated with the digital asset, a categorical descriptor of the digital content associated with the digital asset, or any combinations thereof, or the like. In these examples, operation 301 may further include storing the metadata in the database associated with the reference to the digital asset.

As a further example, the data indicative of the digital asset may include data related to the use of the associated content by others. For example, a non-fungible token might include code establishing certain royalties to be provided based on the underlying content being played in a public forum, such as a music streaming platform like Spotify, Pandora, or the like. In this example, operation 301 may include storing such data as royalties charged and collected, as well as date information of such transactions.

The example process may include, for example, operation 302, which includes receiving a request based, at least in part, on a particular input indicative of a particular digital asset. For example, the request may be based on the selection of the particular digital asset. As another example, the request may be a metadata request indicative of one or more preferences for digital assets. For instance, the request may be a request to retrieve assets of a certain genre, play count, assets within a selected play list, or the like. As a further example, operation 302 may include receiving a request based on an indication of one or more wallets and/or other storage locations that contain data indicative of particular assets.

As a further example, operation 302 may comprise receiving a request to initiate an electronic transaction involving the at least one digital asset. For example, operation 302 may include receiving a request to purchase, sell, and/or mint a certain non-fungible token. As another example, operation 302 may include receiving a request to transfer one or more NFTs from one wallet to another wallet. For instance, operation 302 may include receiving a request to transfer an NFT stored on a third party platform providing hot wallet services to another wallet, such as a hot wallet associated with the database, and/or to a warm/cold wallet located at a given address.

In some examples, the request may be triggered, in whole or in part, by events other than the particular input. For example, the particular input may be to include a certain genre in a playlist. The request for data may be triggered by a user obtaining a non-fungible token associated with digital content that matches the genre.

The example process may include, for example, operation 303, which includes determining, based at least in part on the request, data indicative of the particular digital asset. For example, operation 303 may include retrieving a wallet address and/or access information to a token associated with the digital asset. As another example, operation 303 may include retrieving the digital content corresponding to the resource identifier. For instance, operation 303 may comprise downloading and/or playing the digital content from a location identified by the resource identifier. As a further example, operation 303 may include retrieving and/or determining a list of records of data indicative of a plurality of assets. For example, operation 303 may include may include formulating a list of digital assets matching certain criteria, such as a date range of when the asset was acquired, when the underlying content was released, or the like, or criteria based on metadata stored in association with the digital assets, or the like.

The example process may include, for example, operation 304, which includes making the determined data available for use. For example, operation 304 might include making the determined data available for use by a mobile application, web browser, and/or web-based service. For instance, operation 304 may comprise making the associated digital content available for the mobile application to present to a user. As another example, operation 304 might include providing a listing of available digital assets. For example, operation 304 might include providing data related to financial information related to various NFTs such as purchase date, purchase price, purchase fees, royalties charged, royalties collected, sale date, gain and/or loss, or the like. As another example, operation 304 might include providing a listing of NFTs, their associated digital content, and any metadata associated therewith. For example, operation 304 may comprise providing an interface for the creation of user-configurable play lists and/or other groupings.

As another example, operation 304 may include making the data available, in whole or in part, for use by a distributed application. For example, operation 304 may include transferring a token to another user via the distributed application. As another example, operation 304 may comprise providing a description and/or other data related to purchased and/or purchasable NFTs. For instance, operation 304 may comprise presenting a list of NFTs the user is willing to sell in a distributed application with other participants. As another example, operation 304 may comprise connecting a wallet to a distributed application. For instance, the data may be indicative of a wallet address storing digital assets, and operation 304 may comprise sharing the wallet address via the distributed application. As an example, the wallet address might be the address of a vault providing an API for minting non-fungible tokens indicative of digital assets.

As another example, operation 304 may include making, in whole or in part, the data available for use by an online exchange, a program to facilitate online transactions, an electronically distributed ledger, or the like. Such an exchange may be a hosted exchange, a distributed exchange, or a combination there-of. In this example, operation 304 may include initiating an electronic transaction involving the digital asset. For example, initiating the electronic transaction may comprise making a call to an API and/or performing other operations established by a transaction protocol associated with the digital asset.

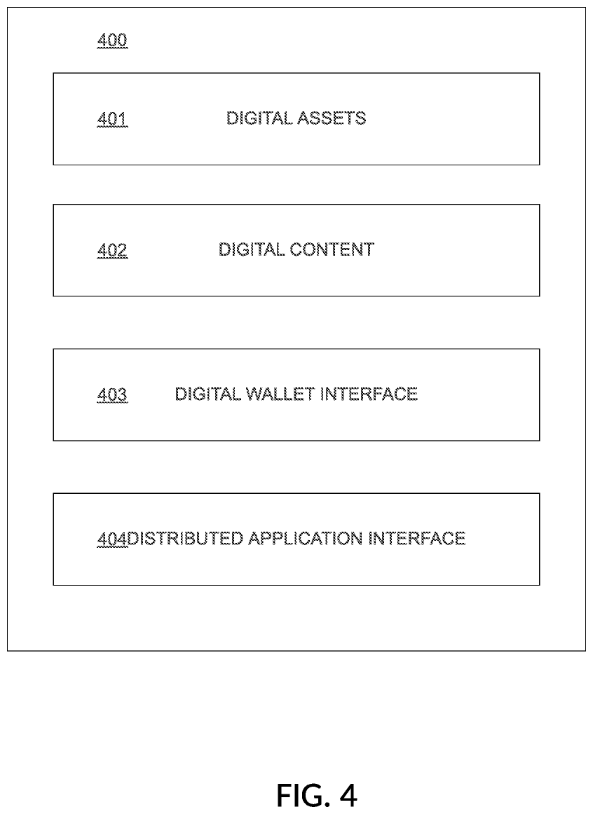

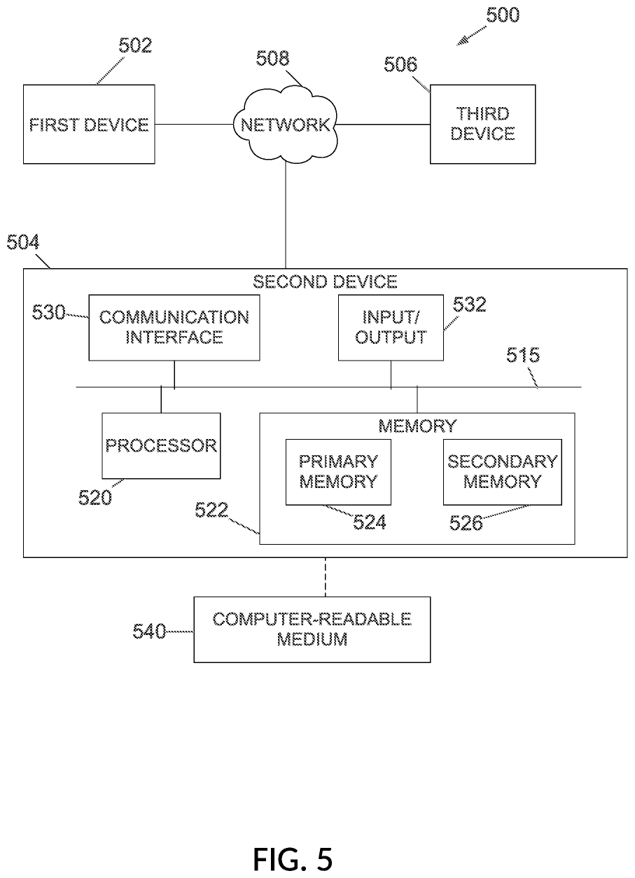

FIG. 4 is a diagram of an implementation of an example system 400 that may be utilized, in whole or in part, for management of digital assets. For example, FIG. 4 may be implemented via one or more software components to perform various implementations of the methods described with respect to FIGS. 2 and 3. In some implementations, system 400 may be embodied on a device such as one of user devices 102, 103, 104, 105 described with respect to FIG. 1 and/or devices 502, 506, 504 described with respect to FIG. 5. For example, system 400 may be implemented, in whole or in part, as a web-based service (such as a web-based service running on servers 106 of data center 106 of FIG. 1, and/or devices 502, 506, 504 described with respect to FIG. 5, etc.) that may be interfaced with via a web browser, as a mobile and/or desktop application, via various embedded components, a combination thereof, or the like. In various implementations, components of system 400 may be co-located on a common computing device and/or may be distributed across a number of different computing devices. For example, system 400 may be implemented, in whole or in part, via one or more network-connected computing devices, such as in the example implementation described with respect to FIG. 5.

Example system 400 includes a digital asset management component 401. For example, the digital asset management component may be programmed to perform the method described with respect to FIG. 2 to enable the organization and management of data indicative of digital assets. For example, component 401 may receive inputs associated with tokens associated with underlying digital content. In some examples, component 401 may include a database that stores data indicative of digital assets, and/or may include an interface to such a database. In this example, component 401 may be programmed to display lists of purchased non-fungible tokens and to provide interfaces to control the organization and storage of such tokens. For example, component 401 may perform delegated transactions on electronically distributed ledgers to control the placement of tokens in user-configurable storage locations, such as wallets. As another example, component 401 may provide an interface to connect to other locations storing such data. For instance, component 401 may provide an interface to a third-party service storing tokens and may provide a proxy to allow interaction with the third party service via component 401.

As further examples, component 401 may comprise an interface to a digital exchange and/or other online platform for conducting digital transactions. In these examples, component 401 may provide an interface to browse available digital assets, and/or to purchase and/or sell such assets. For instance, a content provider may push and/or provide a listing of newly available tokens related to newly released digital content. As another example, component 401 may provide an interface to allow the transfer of such data to other devices.

Example system 400 includes a digital content management component 402. For example, the digital content management component 402 may be programmed to perform the method described with respect to FIG. 2 with respect to the organization and presentation of digital content associated with the digital assets managed by component 401. For example, component 402 may provide an interface listing available pieces of art, such as music files, that are associated with digital assets managed by component 401. Such an interface may include programming to allow a user to create grouping such as playlists, to add newly available digital content to existing groupings, and/or to create, modify, and/or present metadata associated with the digital content. In some examples, component 402 may include programming to initiate the presentation of the digital content. For example, the component 402 may include an embedded software media player that is connected to a display and/or speakers, and/or may include an interface to an external software media player. For instance, component 402 might display a currently playing playlist and receive signals indicating the addition and/or deletion of an item of digital content to the current playlist. In further examples, component 402 may include programming to call methods and/or functions provided by and/or associated to the data indicative. For example, component 402 may include programming to parse a non-fungible token made available by component 401 to determine a resource identifier for associated digital content. In this example, component 402 may include programming to retrieve the digital content from a location indicated by the resource identifier. For example, such a location might include an internet address, a local storage address, and/or an address on an electronically distributed ledger.

The example system 400 includes a digital wallet interface component 403. For example, component 403 may include programming to perform aspects of the methods of FIGS. 2 and/or 3, with respect to the retrieval of data from and/or the placement of data in one or more user-controlled digital wallets. For example, component 403 may be connected to component 401 to receive a newly purchased non-fungible token and to store it in a user-identified digital wallet. As discussed herein, for example, a user-identified digital wallet may include wallets directly or indirectly controlled by a user and/or wallets associated with and/or provided by a third party (e.g., a digital wallet on a crypto exchange, a peer device wallet, etc.). Further, example component 403 may remove a sold and/or transferred digital token from such a digital wallet. In some examples, component 403 may include programming to interface with digital wallets provided by programming instantiated on an electronically distributed ledger (e.g., a smart contract wallet). For instance, component 403 may include programming to request a mint operation from an on-chain smart contract.

The example system further includes distributed application interface component 404. Component 404 may include programming to perform aspects of the methods described with respect to FIGS. 2 and 3 regarding distributed applications. For example, component 404 may comprise an embedded browser that is configured to interface with a distributed application. As various distributed applications may be instantiated on various different electronically distributed ledger technologies, component 404 may include programming to interface with such different technologies. For example, component 404 may include programming to determine a protocol used for interaction with a given distributed application. In this example, component 404 may include programming to format its interactions according to the determined protocol. For instance, component 4040 may include programming to connect a wallet to a distributed application, to interact socially with other holders of digital assets, and/or to engage in transactions with other holders of digital assets.

In the context of the present disclosure, the term “connection,” the term “component” and/or similar terms are intended to be physical, but are not necessarily always tangible. Whether or not these terms refer to tangible subject matter, thus, may vary in a particular context of usage. As an example, a tangible connection and/or tangible connection path may be made, such as by a tangible, electrical connection, such as an electrically conductive path comprising metal and/or other electrical conductor, that is able to conduct electrical current between two tangible components. Likewise, a tangible connection path may be at least partially affected and/or controlled, such that, as is typical, a tangible connection path may be open and/or closed, at times resulting from influence of one or more externally derived signals, such as external currents and/or voltages, such as for an electrical switch. Non-limiting illustrations of an electrical switch include a transistor, a diode, etc. However, a “connection” and/or “component,” in a particular context of usage, likewise, although physical, can also be non-tangible, such as a connection between a client and a server over a network, which generally refers to the ability for the client and server to transmit, receive, and/or exchange communications, as discussed in more detail later.

With this in mind, a particular implementation of a use case and/or scenario will be discussed herein as a way of non-limiting example that may be used, in whole or in part, to facilitate and/or support one or more operations and/or techniques for managing digital assets, such as in connection with one or more operations and/or processes discussed above. Thus, a user of a particular computing device (e.g., user device 102, 103, 104, and/or 105 of FIG. 1, device 502, 504, and/or 506 of FIG. 5, etc.) may, for example, access one or more servers (e.g., servers 107 of FIG. 1, another device 502, 504, and/or 506 of FIG. 5, etc.), such as via a suitable communications network (e.g., communications network 109 of FIG. 1, network 508 of FIG. 5, etc.) and may download a particular host application capable of facilitating one or more initial transactions, such as, for example, purchasing one or more digital assets. For example, the host application executing on a device may implement a system 400 of FIG. 4, etc. . . . . In some instances, these or like digital assets may include, for example, one or more crypto-tokens, such as non-fungible tokens (NFTs) and/or other suitable cryptocurrency, as also discussed above (for example, with respect to the methods of FIG. 2 and/or FIG. 3 and/or component 401 of FIG. 4, etc.). A particular host application may further be capable of storing one or more NFTs and/or cryptocurrencies, such as via received user input and/or selection (e.g., via a prompt on a display of a user device, etc.) in one or more applicable digital wallets. As was also indicated, via the described infrastructure, a user may also be capable of suitably organizing NFTs and/or cryptocurrencies, such as within various digital wallets, for example, among other tasks, as discussed herein (for example, with respect to component 403 of FIG. 4, etc.). For example, a host application may allow a user to suitably consolidate various types of NFTs and/or cryptocurrencies into a particular digital wallet.

Continuing with the example use case and/or scenario, having downloaded a host application and having obtained one or more suitable NFTs, a user may activate such one or more NFTs, such as for one or more particular uses, as discussed herein (for example, with respect to component 402 of FIG. 4, etc.) As a way of illustration, in some instances, these or like NFTs may comprise, for example, one or more so-called “music NFTs.” Typically, music NFTs are NFTs that are linked to or associated with music or some other mode of expression (e.g., performance, art, etc.), such as one or more digital files of songs, poetry, classical music, videos, etc., for example. Music NFTs are typically backed by one or more units of unique code or computer-executable program that provide a secure record of ownership on an electronically distributed ledger. It should be noted that “music NFTs” are used herein in a general sense, such as for ease of description and/or understanding of subject matter, and as such should not be limited to “music.” For example, as was indicated, NFTs associated with any other suitable medium and/or mode of expression may be employed herein, such as without deviating from the scope and spirit of the present disclosure.

Subsequently, a user may, for example, utilize a host application to access and/or retrieve one or more music NFTs, such as via an associated resource identifier (e.g., a URL, etc.), for example, to be played to the user (e.g., using speakers of a user device, etc.), as discussed herein (for example, with respect to component 403 of FIG. 4, etc.). Activation of music NFTs (e.g., via a user input or on-screen selection, etc.) may further include activating one or more collections of music NFTs, (e.g., in the form of music NFT lists or playlists stored in a digital wallet, etc.) so that one or more associated pieces of music, video, etc. will be played and/or displayed (e.g., on a user device, etc.) one after another without having to activate each music NFT individually. Such lists of music NFTs may be user-managed (e.g., created, shuffled, edited, deleted, etc.), such as via one or more operations and/or techniques discussed herein. For example, via a host application, a user may be provided an interface to allow the user to create a collection of particular NFTs, such as a playlist of music NFTs. The user, via the interface, may organize music NFTs as desired, such as, for example, by musician, by release date, by title, by tempo, by music style, and/or by any other desirable categories, types, etc. As another example, a user may add a music NFT into a currently playing playlist and may have that a particular file (e.g., a song, etc.) associated with the music NFT be played automatically upon satisfying some predetermined condition or input (e.g., immediately, after the currently playing song, at the end or beginning of the playlist, or the like). In this example, songs associated with the playlist may continue to be played after playing such a newly-added music NFT.

As described herein (for example, with respect to operation 205 of FIG. 2, operation 301 of FIG. 3, and/or component 402, etc.), in some instances, a host application running on a user device may allow a user to designate or mark certain music NFTs as favorites, such as via utilization of digital tags, as one particular example. Designation or marking of music NFTs as favorites may be multi-dimensional, such as opposed to a binary “on or off” designation or marking. For example, in addition to tagging a favorite music NFT, a user may tag music NFTs in some other ways, as a user prefers, such as female artists, new artists, top ten artists, or the like. At times, digital tags may also be used, at least in part, in the creation of the above-discussed playlists, for example.

Continuing with the above discussion, in some instances, a host application may further facilitate one or more communications and/or network connections with one or more other digital wallets that contain suitable NFTs and/or cryptocurrency. In these or like instances, one or more techniques and/or processes described above may also be applied to like operations for these one or more other digital wallets. For example, via a host application, a user might activate and/or play music NFTs that may be stored in other wallets, such as wallets associated with and/or provided by a third party (e.g., a digital wallet on a crypto exchange, a peer device wallet, etc.) (for example, as discussed with respect to operation 302 of FIG. 3 and/or component 403 of FIG. 4).

Furthermore, in some instances, a host application may provide an interface (e.g., a graphical user interface (GUI), etc.) for a user to interact with music NFTs. For example, using an associate display, a user of a computing device may be capable of searching for music NFTs and/or cryptocurrency by particular music criteria, such as a musician, release date, tempo, genre, etc., by financial or transactional criteria, such as purchase price, purchase fees, royalties, or the like, and/or any other suitable criteria As an example, via a host application, a user may set an alert about the availability of new NFTs and/or cryptocurrencies. As such, music fans may thereby learn when their favorite singers, bands, etc. have published new music NFTs so that they may listen to and/or purchase them as soon as they wish. Accordingly, as discussed herein, infrastructure for digital asset management, such as in partial- or zero-trust environments, for example, may provide benefits.

In this particular implementation, in accordance with the operations discussed above, a user may be presented with reports or tables that may show various information. For example, a report might display financial information relating to the NFTs and cryptocurrency, such as purchase date, purchase price, purchase fees, royalties charged, royalties collected, sale date, gain or loss, or the like. As another example, a report might display data related to the usage of NFTs, such as the number of times played, which lists the NFT is a member of, which NFTs are marked as favorites, or the like. In some examples, the above-discussed tags may be presented in conjunction with such financial data and/or usage data. Of course, such examples are non-limiting, and other reports could display any combination of this information, or other like information.

In an implementation, in accordance with the operations discussed above (e.g., operation 204 of FIG. 2, operation 304 of FIG. 3, and/or component 404 of FIG. 4, etc.), a user may be provided an interface to use decentralized applications or “dapps”. For example, such dapps may run on platforms surfaced by various blockchain and/or other electronically distributed ledge protocols, such as the Ethereum blockchain. Examples of such dapps include Gem, Foundation, OpenSea, Coinbase NFT, Uniswap, SushiSwap, and the like. As an example, a user may use a dapp wallet instantiated on a blockchain. Such dapps may allow users to interact via web services, such as social networks, in a decentralized manner. For example, a user may access a web-like system, at least in part, by connecting a wallet to a mobile application providing a dapp connection. Such dapps may provide NFTs, tools to manage NFTs, social dapps to interact socially with other users, such as fans connecting with their favorite musical acts, decentralized financial application to lend or borrow cryptocurrencies, and/or other like activities. As discussed above, an example implementation of infrastructure for digital asset management may provide a wallet extension to interface with various dapps. As another example, an implementation may provide an embedded browser allowing a user to search, manipulate, and/or otherwise interact with dapps and websites. In some instances, the embedded browser may include bookmarks or other history information of visited and/or selected dapps and websites for ease of future access.

In a particular context of usage, such as a particular context in which tangible components are being discussed, therefore, the terms “coupled” and “connected” are used in a manner so that the terms are not synonymous. Similar terms may also be used in a manner in which a similar intention is exhibited. Thus, “connected” is used to indicate that two or more tangible components and/or the like, for example, are tangibly in direct physical contact. Thus, using the previous example, two tangible components that are electrically connected are physically connected via a tangible electrical connection, as previously discussed. However, “coupled,” is used to mean that potentially two or more tangible components are tangibly in direct physical contact. Nonetheless, is also used to mean that two or more tangible components and/or the like are not necessarily tangibly in direct physical contact, but are able to co-operate, liaise, and/or interact, such as, for example, by being “optically coupled.” Likewise, the term “coupled” may be understood to mean indirectly connected in an appropriate context. It is further noted, in the context of the present disclosure, the term physical if used in relation to memory, such as memory components and/or memory states, as examples, necessarily implies that memory, such memory components and/or memory states, continuing with the example, is tangible.

Unless otherwise indicated, in the context of the present disclosure, the term “or” if used to associate a list, such as A, B, or C, is intended to mean A, B, and C, here used in the inclusive sense, as well as A, B, or C, here used in the exclusive sense. With this understanding, “and” is used in the inclusive sense and intended to mean A, B, and C; whereas “and/or” can be used in an abundance of caution to make clear that all of the foregoing meanings are intended, although such usage is not required. In addition, the term “one or more” and/or similar terms is used to describe any feature, structure, characteristic, and/or the like in the singular, “and/or” is also used to describe a plurality and/or some other combination of features, structures, characteristics, and/or the like. Furthermore, the terms “first,” “second” “third,” and the like are used to distinguish different aspects, such as different components, as one example, rather than supplying a numerical limit and/or suggesting a particular order, unless expressly indicated otherwise. Likewise, the term “based on” and/or similar terms are understood as not necessarily intending to convey an exhaustive list of factors, but to allow for existence of additional factors not necessarily expressly described.

Furthermore, it is intended, for a situation that relates to implementation of claimed subject matter and is subject to testing, measurement, and/or specification regarding degree, to be understood in the following manner. As an example, in a given situation, assume a value of a physical property is to be measured. If, alternatively, reasonable approaches to testing, measurement, and/or specification regarding degree, at least with respect to the property, continuing with the example, is reasonably likely to occur to one of ordinary skill, at least for implementation purposes, claimed subject matter is intended to cover those alternatively reasonable approaches unless otherwise expressly indicated. As an example, if a plot of measurements over a region is produced and implementation of claimed subject matter refers to employing a measurement of slope over the region, but a variety of reasonable and alternative techniques to estimate the slope over that region exist, claimed subject matter is intended to cover those reasonable alternative techniques, even if those reasonable alternative techniques do not provide identical values, identical measurements and/or identical results, unless otherwise expressly indicated.

It is further noted that the terms “type” and/or “like,” if used, such as with a feature, structure, characteristic, and/or the like, using “optical” and/or “electrical” as simple examples, means at least partially of and/or relating to the feature, structure, characteristic, and/or the like in such a way that presence of minor variations, even variations that might otherwise not be considered fully consistent with the feature, structure, characteristic, and/or the like, do not in general prevent the feature, structure, characteristic, and/or the like from being of a “type” and/or being “like,” (such as being an “optical-type” or being “optical-like,” for example) if the minor variations are sufficiently minor so that the feature, structure, characteristic, and/or the like would still be considered to be predominantly present with such variations also present. Thus, continuing with this example, the terms optical-type and/or optical-like properties are necessarily intended to include optical properties. Likewise, the terms electrical-type and/or electrical-like properties, as another example, are necessarily intended to include electrical properties. It should be noted that the specification of the present disclosure merely provides one or more illustrative examples and claimed subject matter is intended to not be limited to one or more illustrative examples; however, again, as has always been the case with respect to the specification of a patent application, particular context of description and/or usage provides helpful guidance regarding reasonable inferences to be drawn.

With advances in technology, it has become more typical to employ distributed computing and/or communication approaches in which portions of a process, such as signal processing of signal samples, for example, may be allocated among various devices, including one or more client devices, one or more server devices and/or one or more peer-to-peer devices, via a computing and/or communications network, for example (e.g., environment 100 of FIG. 1 and/or system 500 of FIG. 5, etc.). A network may comprise two or more devices, such as network devices and/or computing devices, and/or may couple devices, such as network devices and/or computing devices (e.g., devices 102, 103, 104, 114, 116, and/or 107 connected via network 109 and/or links 114, 115, 116 of FIG. 1, and/or devices 502, 506, and/or 504 connected via network 508 of FIG. 5, etc.), so that signal communications, such as in the form of signal packets and/or signal frames (e.g., comprising one or more signal samples), for example, may be exchanged, such as between a server device, a client device and/or a peer-to-peer device, as well as other types of devices, including between wired and/or wireless devices coupled via a wired and/or wireless network, for example.

An example of a distributed computing system (e.g., data center 106 of FIG. 1, and/or system 500 of FIG. 5, etc.) comprises the so-called Hadoop distributed computing system, which employs a map-reduce type of architecture. In the context of the present disclosure, the terms map-reduce architecture and/or similar terms are intended to refer to a distributed computing system implementation and/or embodiment for processing and/or for generating larger sets of signal samples employing map and/or reduce operations for a parallel, distributed process performed over a network of devices. A map operation and/or similar terms refer to processing of signals (e.g., signal samples) to generate one or more key-value pairs and to distribute the one or more pairs to one or more devices of the system (e.g., network). A reduce operation and/or similar terms refer to processing of signals (e.g., signal samples) via a summary operation (e.g., such as counting the number of students in a queue, yielding name frequencies, etc.). A system may employ such an architecture, such as by marshaling distributed server devices (e.g., servers 107 of FIG. 1, etc.), executing various tasks in parallel, and/or managing communications, such as signal transfers, between various parts of the system (e.g., network), in an embodiment. As mentioned, one non-limiting, but well-known, example comprises the Hadoop distributed computing system. It refers to an open-source implementation and/or embodiment of a map-reduce type architecture (available from the Apache Software Foundation, 1901 Munsey Drive, Forrest Hill, MD, 21050-2747), but may include other aspects, such as the Hadoop distributed file system (HDFS) (available from the Apache Software Foundation, 1901 Munsey Drive, Forrest Hill, MD, 21050-2747). In general, therefore, “Hadoop” and/or similar terms (e.g., “Hadoop-type,” etc.) refer to an implementation and/or embodiment of a scheduler for executing larger processing jobs using a map-reduce architecture over a distributed system. Furthermore, in the context of the present disclosure, use of the term “Hadoop” is intended to include versions, presently known and/or to be later developed.

In the context of the present disclosure, the term “network device” refers to any device capable of communicating via and/or as part of a network and may comprise a computing device (e.g., devices 102, 103, 104, 114, 116, and/or 107 connected via network 109 and/or links 114, 115, 116 of FIG. 1, and/or devices 502, 506, and/or 504 connected via network 508 of FIG. 5, etc.). While network devices may be capable of communicating signals (e.g., signal packets and/or frames), such as via a wired and/or wireless network (e.g., networks 109 and/or 110 of FIG. 1 and/or network 508 of FIG. 5, etc.), they may also be capable of performing operations associated with a computing device, such as arithmetic and/or logic operations, processing and/or storing operations (e.g., storing signal samples), such as in a non-transitory memory as tangible, physical memory states, and/or may, for example, operate as a server device and/or a client device in various embodiments. Network devices capable of operating as a server device, a client device and/or otherwise, may include, as examples, dedicated rack-mounted servers, desktop computers, laptop computers, set top boxes, tablets, netbooks, smart phones, wearable devices, integrated devices combining two or more features of the foregoing devices, and/or the like, or any combination thereof. As mentioned, signal packets and/or frames, for example, may be exchanged, such as between a server device and/or a client device, as well as other types of devices, including between wired and/or wireless devices coupled via a wired and/or wireless network, for example, or any combination thereof. It is noted that the terms, server, server device, server computing device, server computing platform and/or similar terms are used interchangeably. Similarly, the terms client, client device, client computing device, client computing platform and/or similar terms are also used interchangeably. While in some instances, for ease of description, these terms may be used in the singular, such as by referring to a “client device” and/or a “server device,” the description is intended to encompass one or more client devices and/or one or more server devices, as appropriate. Along similar lines, references to a “database” are understood to mean, one or more databases and/or portions thereof, as appropriate.

It should be understood that for ease of description, a network device (also referred to as a networking device) may be embodied and/or described in terms of a computing device and vice-versa. However, it should further be understood that this description should in no way be construed so that claimed subject matter is limited to one embodiment, such as only a computing device and/or only a network device, but, instead, may be embodied as a variety of devices or combinations thereof, including, for example, one or more illustrative examples.

A network (e.g., network 109 and/or 110 of FIG. 1 and/or network 508 of FIG. 5, etc.) may also include now known, and/or to be later developed arrangements, derivatives, and/or improvements, including, for example, past, present and/or future mass storage, such as network attached storage (NAS), a storage area network (SAN), and/or other forms of device readable media, for example. A network may include a portion of the Internet, one or more local area networks (LANs), one or more wide area networks (WANs), wire-line type connections, wireless type connections, other connections, or any combination thereof. Thus, a network may be worldwide in scope and/or extent. Likewise, sub-networks, such as may employ differing architectures and/or may be substantially compliant and/or substantially compatible with differing protocols, such as network computing and/or communications protocols (e.g., network protocols), may interoperate within a larger network.

In the context of the present disclosure, the term sub-network and/or similar terms, if used, for example, with respect to a network, refers to the network and/or a part thereof. Sub-networks may also comprise links, such as physical links, connecting and/or coupling nodes, so as to be capable to communicate signal packets and/or frames between devices of particular nodes, including via wired links, wireless links, or combinations thereof. Various types of devices, such as network devices and/or computing devices, may be made available so that device interoperability is enabled and/or, in at least some instances, may be transparent. In the context of the present disclosure, the term “transparent,” if used with respect to particular communicating devices of a network, refers to the devices communicating via the network in which the devices are able to communicate via one or more intermediate devices, such as of one or more intermediate nodes, but without the communicating devices necessarily specifying the one or more intermediate nodes and/or the one or more intermediate devices of the one or more intermediate nodes. Thus, a network may include the one or more intermediate nodes and/or the one or more intermediate devices of the one or more intermediate nodes in communications and the network may engage in communications via the one or more intermediate nodes and/or the one or more intermediate devices of the one or more intermediate nodes, but the network may operate as if such intermediate nodes and/or intermediate devices are not necessarily involved in communications between the particular communicating devices. For example, a router may provide a link and/or connection between otherwise separate and/or independent LANs.

In the context of the present disclosure, a “private network” refers to a particular, limited set of devices, such as network devices and/or computing devices, able to communicate with other devices, such as network devices and/or computing devices, in the particular, limited set, such as via signal packet and/or signal frame communications, for example, without a need for re-routing and/or redirecting signal communications. A private network may comprise a stand-alone network; however, a private network may also comprise a subset of a larger network, such as, for example, without limitation, all or a portion of the Internet. Thus, for example, a private network “in the cloud” may refer to a private network that comprises a subset of the Internet. Although signal packet and/or frame communications (e.g., signal communications) may employ intermediate devices of intermediate nodes to exchange signal packets and/or signal frames, those intermediate devices may not necessarily be included in the private network by not being a source and/or designated destination for one or more signal packets and/or signal frames, for example. It is understood in the context of the present disclosure that a private network may direct outgoing signal communications to devices not in the private network, but devices outside the private network may not necessarily be able to direct inbound signal communications to devices included in the private network.

The Internet refers to a decentralized global network of interoperable networks that comply with the Internet Protocol (IP). It is noted that there are several versions of the Internet Protocol. The term Internet Protocol, IP, and/or similar terms are intended to refer to any version, now known and/or to be later developed. The Internet includes local area networks (LANs), wide area networks (WANs), wireless networks, and/or long-haul networks that, for example, may allow signal packets and/or frames to be communicated between LANs. The term World Wide Web (WWW or Web) and/or similar terms may also be used, although it refers to a part of the Internet that complies with the Hypertext Transfer Protocol (HTTP). For example, network devices may engage in an HTTP session through an exchange of appropriately substantially compatible and/or substantially compliant signal packets and/or frames. It is noted that there are several versions of the Hypertext Transfer Protocol. The term Hypertext Transfer Protocol, HTTP, and/or similar terms are intended to refer to any version, now known and/or to be later developed. It is likewise noted that in various places in this document substitution of the term Internet with the term World Wide Web (“Web”) may be made without a significant departure in meaning and may, therefore, also be understood in that manner if the statement would remain correct with such a substitution.

Although claimed subject matter is not in particular limited in scope to the Internet and/or to the Web; nonetheless, the Internet and/or the Web may without limitation provide a useful example of an embodiment at least for purposes of illustration. As indicated, the Internet and/or the Web may comprise a worldwide system of interoperable networks, including interoperable devices within those networks. The Internet and/or Web has evolved to a self-sustaining facility accessible to potentially billions of people or more worldwide. Also, in an embodiment, and as mentioned above, the terms “WWW” and/or “Web” refer to a part of the Internet that complies with the Hypertext Transfer Protocol. The Internet and/or the Web, therefore, in the context of the present disclosure, may comprise a service that organizes stored digital content, such as, for example, text, images, video, etc., through the use of hypermedia, for example. It is noted that a network, such as the Internet and/or Web, may be employed to store electronic files and/or electronic documents.

The term “electronic file” and/or the term “electronic document” or the like are used throughout this document to refer to a set of stored memory states and/or a set of physical signals associated in a manner so as to thereby at least logically form a file (e.g., electronic) and/or an electronic document. That is, it is not meant to implicitly reference a particular syntax, format and/or approach used, for example, with respect to a set of associated memory states and/or a set of associated physical signals. If a particular type of file storage format and/or syntax, for example, is intended, it is referenced expressly. It is further noted an association of memory states, for example, may be in a logical sense and not necessarily in a tangible, physical sense. Thus, although signal and/or state components of a file and/or an electronic document, for example, are to be associated logically, storage thereof, for example, may reside in one or more different places in a tangible, physical memory, in an embodiment.

A Hyper Text Markup Language (“HTML”), for example, may be utilized to specify digital content and/or to specify a format thereof, such as in the form of an electronic file and/or an electronic document, such as a Web page, Web site, etc., for example. An Extensible Markup Language (“XML”) may also be utilized to specify digital content and/or to specify a format thereof, such as in the form of an electronic file and/or an electronic document, such as a Web page, Web site, etc., in an embodiment. Of course, HTML and/or XML are merely examples of “markup” languages, provided as non-limiting illustrations. Furthermore, HTML and/or XML are intended to refer to any version, now known and/or to be later developed, of these languages. Likewise, claimed subject matter are not intended to be limited to examples provided as illustrations, of course.

In the context of the present disclosure, the term “Web site” and/or similar terms refer to Web pages that are associated electronically to form a particular collection thereof. Also, in the context of the present disclosure, “Web page” and/or similar terms refer to an electronic file and/or an electronic document accessible via a network (e.g., network 109 and/or 110 of FIG. 1 and/or network 508 of FIG. 5, etc.), including by specifying a uniform resource locator (URL) (e.g., resource identifier discussed with respect to operations 203 and/or 204 of FIG. 2, operations 301 and/or 303 of FIG. 3 and/or component 402 of FIG. 4, etc.) for accessibility via the Web, in an example embodiment. As alluded to above, in one or more embodiments, a Web page may comprise digital content coded (e.g., via computer instructions) using one or more languages, such as, for example, markup languages, including HTML and/or XML, although claimed subject matter is not limited in scope in this respect. Also, in one or more embodiments, application developers may write code (e.g., computer instructions) in the form of JavaScript (or other programming languages), for example, executable by a computing device to provide digital content to populate an electronic document and/or an electronic file in an appropriate format, such as for use in a particular application, for example. Use of the term “JavaScript” and/or similar terms intended to refer to one or more particular programming languages are intended to refer to any version of the one or more programming languages identified, now known and/or to be later developed. Thus, JavaScript is merely an example programming language. As was mentioned, claimed subject matter is not intended to be limited to examples and/or illustrations.

As was indicated, in the context of the present disclosure, the terms “entry,” “electronic entry,” “document,” “electronic document,” “content”, “digital content,” “item,” “object,” and/or similar terms are meant to refer to signals and/or states in a physical format, such as a digital signal and/or digital state format, e.g., that may be perceived by a user if displayed, played, tactilely generated, etc. and/or otherwise executed by a device, such as a digital device, including, for example, a computing device, but otherwise might not necessarily be readily perceivable by humans (e.g., if in a digital format). Likewise, in the context of the present disclosure, digital content provided to a user in a form so that the user is able to readily perceive the underlying content itself (e.g., content presented in a form consumable by a human, such as hearing audio, feeling tactile sensations and/or seeing images, as examples) is referred to, with respect to the user, as “consuming” digital content, “consumption” of digital content, “consumable” digital content and/or similar terms. For one or more embodiments, an electronic document and/or an electronic file may comprise a Web page of code (e.g., computer instructions) in a markup language executed and/or to be executed by a computing and/or networking device, for example. In another embodiment, an electronic document and/or electronic file may comprise a portion and/or a region of a Web page. However, claimed subject matter is not intended to be limited in these respects.

Also, for one or more embodiments, an electronic document and/or electronic file (e.g., digital content and/or digital wallets as discussed herein, etc.) may comprise a number of components. As previously indicated, in the context of the present disclosure, a component is physical, but is not necessarily tangible. As an example, components with reference to an electronic document and/or electronic file, in one or more embodiments, may comprise text, for example, in the form of physical signals and/or physical states (e.g., capable of being physically displayed and/or maintained as a memory state in a tangible memory). Typically, memory states, for example, comprise tangible components, whereas physical signals are not necessarily tangible, although signals may become (e.g., be made) tangible, such as if appearing on a tangible display, for example, as is not uncommon. Also, for one or more embodiments, components with reference to an electronic document and/or electronic file may comprise a graphical object, such as, for example, an image, such as a digital image, and/or sub-objects, including attributes thereof, which, again, comprise physical signals and/or physical states (e.g., capable of being tangibly displayed and/or maintained as a memory state in a tangible memory). In an embodiment, digital content may comprise, for example, text, images, audio, video, haptic content and/or other types of electronic documents and/or electronic files, including portions thereof, for example.

Also, in the context of the present disclosure, the term parameters (e.g., one or more parameters) refer to material descriptive of a collection of signal samples, such as one or more electronic documents and/or electronic files, and exist in the form of physical signals and/or physical states, such as memory states. For example, one or more parameters, such as referring to an electronic document and/or an electronic file comprising an image, may include, as examples, time of day at which an image was captured, latitude and longitude of an image capture device, such as a camera, for example, etc. In another example, one or more parameters relevant to digital content, such as digital content comprising a technical article, as an example, may include one or more authors, for example. Claimed subject matter is intended to embrace meaningful, descriptive parameters in any format, so long as the one or more parameters comprise physical signals and/or states, which may include, as parameter examples, collection name (e.g., electronic file and/or electronic document identifier name), technique of creation, purpose of creation, time and date of creation, logical path if stored, coding formats (e.g., type of computer instructions, such as a markup language) and/or standards and/or specifications used so as to be protocol compliant (e.g., meaning substantially compliant and/or substantially compatible) for one or more uses, and so forth.

Signal packet communications and/or signal frame communications, also referred to as signal packet transmissions and/or signal frame transmissions (or merely “signal packets” and/or “signal frames”), may be communicated between nodes of a network, where a node may comprise one or more network devices and/or one or more computing devices, for example (e.g., devices 102, 103, 104, 114, 116, and/or 107 connected via network 109 and/or links 114, 115, 116 of FIG. 1, and/or devices 502, 506, and/or 504 connected via network 508 of FIG. 5, etc.). As an illustrative example, but without limitation, a node may comprise one or more sites employing a local network address, such as in a local network address space. Likewise, a device, such as a network device and/or a computing device, may be associated with that node. It is also noted that in the context of this disclosure, the term “transmission” is intended as another term for a type of signal communication that may occur in any one of a variety of situations. Thus, it is not intended to imply a particular directionality of communication and/or a particular initiating end of a communication path for the “transmission” communication. For example, the mere use of the term in and of itself is not intended, in the context of the present disclosure, to have particular implications with respect to the one or more signals being communicated, such as, for example, whether the signals are being communicated “to” a particular device, whether the signals are being communicated “from” a particular device, and/or regarding which end of a communication path may be initiating communication, such as, for example, in a “push type” of signal transfer and/or in a “pull type” of signal transfer. In the context of the present disclosure, push and/or pull type signal transfers are distinguished by which end of a communications path initiates signal transfer.

Thus, a signal packet and/or frame may, as an example, be communicated via a communication channel and/or a communication path, such as comprising a portion of the Internet and/or the Web, from a site via an access node coupled to the Internet or vice-versa. Likewise, a signal packet and/or frame may be forwarded via network nodes to a target site coupled to a local network, for example. A signal packet and/or frame communicated via the Internet and/or the Web, for example, may be routed via a path, such as either being “pushed” and/or “pulled,” comprising one or more gateways, servers, etc. that may, for example, route a signal packet and/or frame, such as, for example, substantially in accordance with a target and/or destination address and availability of a network path of network nodes to the target and/or destination address. Although the Internet and/or the Web comprise a network of interoperable networks, not all of those interoperable networks are necessarily available and/or accessible to the public.

In the context of the particular disclosure, a network protocol, such as for communicating between devices of a network (e.g., network 109 and/or 110 of FIG. 1 and/or network 508 of FIG. 5, etc.), may be characterized, at least in part, substantially in accordance with a layered description, such as the so-called Open Systems Interconnection (OSI) seven-layer type of approach and/or description. A network computing and/or communications protocol (also referred to as a network protocol) refers to a set of signaling conventions, such as for communication transmissions, for example, as may take place between and/or among devices in a network. In the context of the present disclosure, the term “between” and/or similar terms are understood to include “among” if appropriate for the particular usage and vice-versa. Likewise, in the context of the present disclosure, the terms “compatible with,” “comply with” and/or similar terms are understood to respectively include substantial compatibility and/or substantial compliance.

A network protocol, such as protocols characterized substantially in accordance with the aforementioned OSI description, has several layers. These layers are referred to as a network stack. Various types of communications (e.g., transmissions), such as network communications, may occur across various layers. A lowest level layer in a network stack, such as the so-called physical layer, may characterize how symbols (e.g., bits and/or bytes) are communicated as one or more signals (and/or signal samples) via a physical medium (e.g., twisted pair copper wire, coaxial cable, fiber optic cable, wireless air interface, combinations thereof, etc.). Progressing to higher-level layers in a network protocol stack, additional operations and/or features may be available via engaging in communications that are substantially compatible and/or substantially compliant with a particular network protocol at these higher-level layers. For example, higher-level layers of a network protocol may, for example, affect device permissions, user permissions, etc.

A network and/or sub-network, in an embodiment, may communicate via signal packets and/or signal frames, such via participating digital devices and may be substantially compliant and/or substantially compatible with, but is not limited to, now known and/or to be developed, versions of any of the following network protocol stacks: ARCNET, AppleTalk, ATM, Bluetooth, DECnet, Ethernet, FDDI, Frame Relay, HIPPI, IEEE 1394, IEEE 802.11, IEEE-488, Internet Protocol Suite, IPX, Myrinet, OSI Protocol Suite, QsNet, RS-232, SPX, System Network Architecture, Token Ring, USB, and/or X.25. A network and/or sub-network may employ, for example, a version, now known and/or later to be developed, of the following: TCP/IP, UDP, DECnet, NetBEUI, IPX, AppleTalk and/or the like. Versions of the Internet Protocol (IP) may include IPv4, IPv6, and/or other later to be developed versions.

Regarding aspects related to a network, including a communications and/or computing network, a wireless network may couple devices, including client devices, with the network (e.g., devices 102, 103, 104, 114, 116, and/or 107 connected via network 109 and/or links 114, 115, 116 of FIG. 1, and/or devices 502, 506, and/or 504 connected via network 508 of FIG. 5, etc.). A wireless network may employ stand-alone, ad-hoc networks, mesh networks, Wireless LAN (WLAN) networks, cellular networks, and/or the like. A wireless network may further include a system of terminals, gateways, routers, and/or the like coupled by wireless radio links, and/or the like, which may move freely, randomly and/or organize themselves arbitrarily, such that network topology may change, at times even rapidly. A wireless network may further employ a plurality of network access technologies, including a version of Long Term Evolution (LTE), WLAN, Wireless Router (WR) mesh, 2nd, 3rd, 4^{th}, and/or 5th generation (2G, 3G, 4G, and/or 5G) cellular technology and/or the like, whether currently known and/or to be later developed. Network access technologies may enable wide area coverage for devices, such as computing devices and/or network devices, with varying degrees of mobility, for example.

A network may enable radio frequency and/or other wireless type communications via a wireless network access technology and/or air interface, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, ultra-wideband (UWB), IEEE 802.11 (including, but not limited to, IEEE 802.11b/g/n), and/or the like. A wireless network may include virtually any type of now known and/or to be developed wireless communication mechanism and/or wireless communications protocol by which signals may be communicated between devices, between networks, within a network, and/or the like, including the foregoing, of course.

Turning now to FIG. 5, FIG. 5 illustrates an example system embodiment of a network-connected device providing an infrastructure for data management (e.g. devices 102, 103, 104, 114, 116, and/or 107 connected via network 109 and/or links 114, 115, 116 of FIG. 1, etc.). For example, the illustrated devices and network may be deployed in an example environment such as the example discussed with respect to FIG. 1. In one example embodiment, as shown in FIG. 5, a system embodiment may comprise a local network (e.g., a second device 504 and a computer-readable medium 540) and/or another type of network, such as a computing and/or communications network (e.g., networks 109 and/or 110 and/or links 114 of FIG. 1, etc.). For purposes of illustration, therefore, FIG. 5 shows an embodiment 500 of a system that may be employed to implement either type or both types of networks. Network 508 may comprise one or more network connections, links, processes, services, applications, and/or resources to facilitate and/or support communications, such as an exchange of communication signals, for example, between a computing device, such as 502, and another computing device, such as 506, which may, for example, comprise one or more client computing devices and/or one or more server computing device. By way of example, but not limitation, network 508 may comprise wireless and/or wired communication links, telephone and/or telecommunications systems, Wi-Fi networks, Wi-MAX networks, the Internet, a local area network (LAN), a wide area network (WAN), or any combinations thereof. For example, network 508 may a network as described with respect to networks 109 or 110 of FIG. 1.

Example devices in FIG. 5 may comprise features, for example, of a client computing device and/or a server computing device, in an embodiment. (e.g., devices 102, 103, 104, 114, 116, and/or 107 of FIG. 1, etc.) It is further noted that the term computing device, in general, whether employed as a client and/or as a server, or otherwise, refers at least to a processor and a memory connected by a communication bus. Likewise, in the context of the present disclosure at least, this is understood to refer to sufficient structure within the meaning of 35 § USC 15 (f) so that it is specifically intended that 35 § USC 15 (f) not be implicated by use of the term “computing device” and/or similar terms; however, if it is determined, for some reason not immediately apparent, that the foregoing understanding cannot stand and that 35 § USC 15 (f) therefore, necessarily is implicated by the use of the term “computing device” and/or similar terms, then, it is intended, pursuant to that statutory section, that corresponding structure, material and/or acts for performing one or more functions be understood and be interpreted to be described at least in FIGS. 1 and 5 of the present disclosure.

Referring now to FIG. 5, in some embodiments, first and third devices 502 and 506 may be capable of rendering a graphical user interface (GUI) for a network device and/or a computing device, for example, so that a user-operator may engage in system use (e.g., system 400 of FIG. 4, etc.). In other embodiment, first and/or third devices 502 and 506 may operate in a “headless” manner without a GUI. For example, the devices illustrated may be user devices such as devices 102, 103, 104, 105, server devices such as servers 107, and/or nodes 111, as discussed with respect to FIG. 1. Device 504 may potentially serve a similar function in this illustration. Likewise, in FIG. 5, computing device 502 (‘first device’ in figure) may interface with computing device 504 (‘second device’ in figure), which may, for example, also comprise features of a client computing device and/or a server computing device, in an embodiment. Processor (e.g., processing device) 520 and memory 522, which may comprise primary memory 524 and secondary memory 526, may communicate by way of a communication bus 515, for example. The term “computing device,” in the context of the present disclosure, refers to a system and/or a device, such as a computing apparatus, that includes a capability to process (e.g., perform computations) and/or store digital content, such as electronic files, electronic documents, measurements, text, images, video, audio, etc. in the form of signals and/or states. Thus, a computing device, in the context of the present disclosure, may comprise hardware, software, firmware, or any combination thereof (other than software per se). Computing device 504, as depicted in FIG. 5, is merely one example, and claimed subject matter is not limited in scope to this particular example.

For one or more embodiments, a computing device may comprise, for example, any of a wide range of digital electronic devices, including, but not limited to, desktop and/or notebook computers, high-definition televisions, digital versatile disc (DVD) and/or other optical disc players and/or recorders, game consoles, satellite television receivers, cellular telephones, tablet devices, wearable devices, personal digital assistants, mobile audio and/or video playback and/or recording devices, or any combination of the foregoing. Further, unless specifically stated otherwise, a process as described, such as with reference to flow diagrams and/or otherwise, may also be executed and/or affected, in whole or in part, by a computing device and/or a network device. A device, such as a computing device and/or network device, may vary in terms of capabilities and/or features. Claimed subject matter is intended to cover a wide range of potential variations. For example, a device may include a numeric keypad and/or other display of limited functionality, such as a monochrome liquid crystal display (LCD) for displaying text, for example. In contrast, however, as another example, a web-enabled device may include a physical and/or a virtual keyboard, mass storage, one or more accelerometers, one or more gyroscopes, global positioning system (GPS) and/or other location-identifying type capability, and/or a display with a higher degree of functionality, such as a touch-sensitive color 2D and/or 3D display, for example.

As suggested previously, communications between a computing device and/or a network device and a wireless network may be in accordance with known and/or to be developed network protocols including, for example, global system for mobile communications (GSM), enhanced data rate for GSM evolution (EDGE), long-term evolution (LTE), 802.11b/g/n/h, etc., and/or worldwide interoperability for microwave access (WiMAX). A computing device and/or a networking device may also have a subscriber identity module (SIM) card, which, for example, may comprise a detachable and/or embedded smart card that is able to store subscription content of a user, and/or is also able to store a contact list. A user may own the computing device and/or network device or may otherwise be a user, such as a primary user, for example. A device may be assigned an address by a wireless network operator, a wired network operator, and/or an Internet Service Provider (ISP). For example, an address may comprise a domestic or international telephone number, an Internet Protocol (IP) address, and/or one or more other identifiers. In other embodiments, a computing and/or communications network may be embodied as a wired network, wireless network, or any combinations thereof.

A computing and/or network device may include and/or may execute a variety of now known and/or to be developed operating systems, derivatives and/or versions thereof, including computer operating systems, such as Windows, iOS, Linux, a mobile operating system, such as iOS, Android, Windows Mobile, and/or the like. A computing device and/or network device may include and/or may execute a variety of possible applications, such as a client software application enabling communication with other devices. For example, one or more messages (e.g., content) may be communicated, such as via one or more protocols, now known and/or later to be developed, suitable for communication of e-mail, short message service (SMS), and/or multimedia message service (MMS), including via a network, such as a social network, formed at least in part by a portion of a computing and/or communications network, including, but not limited to, Facebook, LinkedIn, Twitter, Flickr, and/or Google+, to provide only a few examples. A computing and/or network device may also include executable computer instructions to process and/or communicate digital content, such as, for example, textual content, digital multimedia content, and/or the like. A computing and/or network device may also include executable computer instructions to perform a variety of possible tasks, such as browsing, searching, playing various forms of digital content, including locally stored and/or streamed video, and/or games such as, but not limited to, fantasy sports leagues. The foregoing is provided merely to illustrate that claimed subject matter is intended to include a wide range of possible features and/or capabilities.

In FIG. 5, computing device 502 may provide one or more sources of executable computer instructions in the form physical states and/or signals (e.g., stored in memory states), for example. For example, computing device 502 may perform the processes described with respect to FIG. 2 or 3 (e.g., operations 201-205 of FIG. 2 and/or operations 301-304 of FIG. 3) and/or implement a system as described with respect to FIG. 4 (e.g., system 400, etc.). Computing device 502 may communicate with computing device 504 by way of a network connection, such as via network 508, for example (e.g., networks 109 and/or 110 and/or links 114 of FIG. 1, etc.). As previously mentioned, a connection, while physical, may not necessarily be tangible. Although computing device 504 of FIG. 5 shows various tangible, physical components, claimed subject matter is not limited to computing devices having only these tangible components as other implementations and/or embodiments may include alternative arrangements that may comprise additional tangible components or fewer tangible components, for example, that function differently while achieving similar results. Rather, examples are provided merely as illustrations. It is not intended that claimed subject matter be limited in scope to illustrative examples.

Memory 522 may comprise any non-transitory storage mechanism. Memory 522 may comprise, for example, primary memory 524 and secondary memory 526, additional memory circuits, mechanisms, or combinations thereof may be used. Memory 522 may comprise, for example, random access memory, read only memory, etc., such as in the form of one or more storage devices and/or systems, such as, for example, a disk drive including an optical disc drive, a tape drive, a solid-state memory drive, etc., just to name a few examples.

Memory 522 may be utilized to store a program of executable computer instructions. For example, processor 520 may fetch executable instructions from memory and proceed to execute the fetched instructions (e.g., performing operations 201-205 of FIG. 2 and/or operations 301-304 of FIG. 3 and/or implementing a system 400 as described with respect to FIG. 4 etc.). Memory 522 may also comprise a memory controller for accessing device readable-medium 540 that may carry and/or make accessible digital content, which may include code, and/or instructions, for example, executable by processor 520 and/or some other device, such as a controller, as one example, capable of executing computer instructions, for example. Under direction of processor 520, a non-transitory memory, such as memory cells storing physical states (e.g., memory states), comprising, for example, a program of executable computer instructions, may be executed by processor 520 and able to generate signals to be communicated via a network, for example, as previously described. Generated signals may also be stored in memory, also previously suggested. As example, computer-readable medium 504 may store instructions that, responsive to execution by processor 520, cause the processor to perform or control performance of operations described with respect to FIG. 2 or 3.

Memory 522 may store electronic files and/or electronic documents, such as relating to one or more users, and may also comprise a device-readable medium that may carry and/or make accessible content, including code and/or instructions (e.g., digital content and/or digital wallets as discussed herein, etc.), for example, executable by processor 520 and/or some other device, such as a controller, as one example, capable of executing computer instructions, for example. As previously mentioned, the term electronic file and/or the term electronic document are used throughout this document to refer to a set of stored memory states and/or a set of physical signals associated in a manner so as to thereby form an electronic file and/or an electronic document. That is, it is not meant to implicitly reference a particular syntax, format and/or approach used, for example, with respect to a set of associated memory states and/or a set of associated physical signals. It is further noted an association of memory states, for example, may be in a logical sense and not necessarily in a tangible, physical sense. Thus, although signal and/or state components of an electronic file and/or electronic document, are to be associated logically, storage thereof, for example, may reside in one or more different places in a tangible, physical memory, in an embodiment.

Algorithmic descriptions and/or symbolic representations are examples of techniques used by those of ordinary skill in the signal processing and/or related arts to convey the substance of their work to others skilled in the art. An algorithm is, in the context of the present disclosure, and generally, is considered to be a self-consistent sequence of operations and/or similar signal processing leading to a desired result. In the context of the present disclosure, operations and/or processing involve physical manipulation of physical quantities. Typically, although not necessarily, such quantities may take the form of electrical and/or magnetic signals and/or states capable of being stored, transferred, combined, compared, processed and/or otherwise manipulated, for example, as electronic signals and/or states making up components of various forms of digital content, such as signal measurements, text, images, video, audio, etc.

It has proven convenient at times, principally for reasons of common usage, to refer to such physical signals and/or physical states as bits, values, elements, parameters, symbols, characters, terms, numbers, numerals, measurements, content and/or the like. It should be understood, however, that all of these and/or similar terms are to be associated with appropriate physical quantities and are merely convenient labels. Unless specifically stated otherwise, as apparent from the preceding discussion, it is appreciated that throughout this specification discussions utilizing terms such as “processing,” “computing,” “calculating,” “determining”, “establishing”, “obtaining”, “identifying”, “selecting”, “generating”, and/or the like may refer to actions and/or processes of a specific apparatus, such as a special purpose computer and/or a similar special purpose computing and/or network device. In the context of this specification, therefore, a special purpose computer and/or a similar special purpose computing and/or network device is capable of processing, manipulating and/or transforming signals and/or states, typically in the form of physical electronic and/or magnetic quantities, within memories, registers, and/or other storage devices, processing devices, and/or display devices of the special purpose computer and/or similar special purpose computing and/or network device. In the context of this particular disclosure, as mentioned, the term “specific apparatus” therefore includes a general purpose computing and/or network device, such as a general purpose computer, once it is programmed to perform particular functions, such as pursuant to program software instructions.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state and/or thing. For example, but without limitation, for some types of memory devices, a change in state may involve an accumulation and/or storage of charge and/or a release of stored charge. Likewise, in other memory devices, a change of state may comprise a physical change, such as a transformation in magnetic orientation. Likewise, a physical change may comprise a transformation in molecular structure, such as from crystalline form to amorphous form or vice-versa. In still other memory devices, a change in physical state may involve quantum mechanical phenomena, such as, superposition, entanglement, and/or the like, which may involve quantum bits (qubits), for example. The foregoing is not intended to be an exhaustive list of all examples in which a change in state from a binary one to a binary zero or vice-versa in a memory device may comprise a transformation, such as a physical, but non-transitory, transformation. Rather, the foregoing is intended as illustrative examples.

Referring again to FIG. 5, processor 520 may comprise one or more circuits, such as digital circuits, to perform at least a portion of a computing procedure and/or process. By way of example, but not limitation, processor 520 may comprise one or more processors, such as controllers, microprocessors, microcontrollers, application specific integrated circuits, digital signal processors, programmable logic devices, field programmable gate arrays, the like, or any combination thereof. In various implementations and/or embodiments, processor 520 may perform signal processing, typically substantially in accordance with fetched executable computer instructions, such as to manipulate signals and/or states, to construct signals and/or states, etc., with signals and/or states generated in such a manner to be communicated and/or stored in memory, for example.

FIG. 5 also illustrates device 504 as including a component 532 operable with input/output devices, for example, so that signals and/or states may be appropriately communicated between devices, such as device 504 and an input device and/or device 504 and an output device. A user may make use of an input device, such as a computer mouse, stylus, track ball, keyboard, and/or any other similar device capable of receiving user actions and/or motions as input signals (e.g., to interact with a system 400 of FIG. 4, and/or to interact with a device performing the methods of FIGS. 2 and/or 3, etc.). Likewise, a user may make use of an output device, such as a display, a printer, etc., and/or any other device capable of providing signals and/or generating stimuli for a user, such as visual stimuli, audio stimuli and/or other similar stimuli (e.g., to present digital content, as discussed with respect to operation 205 of FIG. 2, operation 304 of FIG. 2, and/or component 402 of FIG. 4).

In the preceding description, various aspects of claimed subject matter have been described. For purposes of explanation, specifics, such as amounts, systems and/or configurations, as examples, were set forth. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all modifications and/or changes as fall within claimed subject matter.

What is claimed is:

1. A method comprising:
receiving one or more digital signals indicative of a particular input;
accessing a database based at least in part on the particular input;
determining, via at least the database, data indicative of at least one digital asset, the data having been formatted according to at least one of a plurality of protocols and including at least a first resource identifier for one or more locations of digital content;
making available the determined data for use by at least one of the following: a mobile application, a distributed application, an online exchange, a content creator, a web-based service, an electronically distributed ledger, a web browser, a program to facilitate online transactions, or any combination thereof;
initiating one or more processes based at least in part on the use of the determined data.

2. The method of claim 1, wherein the one or more locations comprise at least one of the following: a memory, the database, a local storage, a remote storage, or any combination thereof.

3. The method of claim 2, wherein the digital content comprises a plurality of media files, and initiating one or more processes comprises presenting the media files on a computing device.

4. The method of claim 1, wherein the one or more processes comprise:
presenting a list of the digital content on a computing device;
receiving input indicative of a selection of listed digital content; and
retrieving the selected digital content according to the at least one protocol corresponding to the digital content.

5. The method of claim 4, wherein the one or more processes further comprise storing metadata associated with the digital content in the database.

6. The method of claim 1, wherein initiating one or more processes comprises initiating an electronic transaction involving a digital asset of the at least one digital assets, the electronic transaction initiated according to a corresponding protocol of the plurality of protocols.

7. The method of claim 6, wherein initiating the electronic transaction comprises initiating an update of the electronically distributed ledger according to the corresponding protocol.

8. The method of claim 1, wherein determining the data further comprises:
determining whether the data is indicative of an additional digital asset comprising additional digital content and has been formatted according to a different protocol than the at least one of the plurality of protocols, wherein the additional digital content has been identified via a second resource identifier.

9. A method comprising:
storing, in a database, at least one reference to data indicative of at least one digital asset, the data having been formatted according to at least one of a plurality of protocols and including at least one resource identifier for one or more locations of digital content;
receiving a request based, at least in part, on a particular input indicative of a particular digital asset;
determining, based at least in part on the request, data indicative of the particular digital asset; and
making the determined data available for use by at least one of the following: a mobile application, a distributed application, an online exchange, a content creator, a web-based service, an electronically distributed ledger, a web browser, a program to facilitate online transactions, or any combination thereof.

10. The method of claim 9, wherein storing, in the database, at least one reference comprises:
receiving metadata associated with a digital asset, the metadata comprising at least one of the following: an identifier indicative of inclusion in a grouping, a statistic of the digital content associated with the digital asset, a categorical descriptor of the digital content associated with the digital asset, or combinations thereof; and
storing the metadata in the database associated with the reference to the digital asset.

11. The method of claim 10, wherein the particular input comprises a metadata request indicative of one or more preferences for at least the particular digital asset, and
determining data indicative of the particular asset comprises determining at least one digital asset corresponding to the metadata request.

12. The method of claim 9, wherein making available the determined data for use comprises retrieving the digital content corresponding to the resource identifier.

13. The method of claim 9, wherein receiving the request comprises receiving a request to initiate an electronic transaction involving the at least one digital asset, and making the determined data available comprises initiating the electronic transaction according to a transaction protocol of the plurality of protocols.

14. The method of claim 13, wherein initiating the electronic transaction comprises initiating an update to an electronically distributed ledger according to the transaction protocol.

15. A non-transitory computer-readable medium having instructions stored thereon that, responsive to execution by a processor, cause the processor to perform or control performance of operations that comprise:
receiving one or more digital signals indicative of a particular input;
accessing a database based at least in part on the particular input;
determining, via at least the database, data indicative of at least one digital asset, the data having been formatted according to at least one of a plurality of protocols and including at least a first resource identifier for one or more locations of digital content;
making available the determined data for use by at least one of the following: a mobile application, a distributed application, an online exchange, a content creator, a web-based service, an electronically distributed ledger, a web browser, a program to facilitate online transactions, or any combination thereof;
initiating one or more processes based at least in part on the use of the determined data.

16. The non-transitory computer-readable medium of claim 15, wherein the digital content comprises a plurality of media files and initiating one or more processes comprises presenting the media files on a device.

17. The non-transitory computer-readable medium of claim 15, wherein the one or more processes comprise:
presenting a list of the digital content on a computing device;
receiving input indicative of a selection of listed digital content; and
retrieving the selected digital content according to the at least one protocol corresponding to the digital content.

18. The non-transitory computer-readable medium of claim 15, wherein initiating one or more processes comprises initiating an electronic transaction involving a digital asset of the at least one digital assets, the electronic transaction initiated according to a corresponding protocol of the plurality of protocols.

19. The non-transitory computer-readable medium of claim 18, wherein initiating the online transaction comprises initiating an update of the electronically distributed ledger according to the corresponding protocol.

20. The non-transitory computer-readable medium of claim 15, wherein determining the data further comprises determining whether the data is indicative of an additional digital asset comprising additional digital content and has been formatted according to a different protocol than the at least one of the plurality of protocols, wherein the additional digital content has been identified via a second resource identifier.
